(19) United States
(12) Patent Application Publication
(10) Pub. No.: US 2012/0010071 A1
(43) Pub. Date: Jan. 12, 2012

(54) Hemp wick and method for making

(76) Inventor: Eric Mylko, Golden, CO (US)

(21) Appl. No.: 12/803,726

(22) Filed: Jul. 6, 2010

(51) Int. Cl. B01J 20/24

(52) U.S. Cl. 502/404

(57) ABSTRACT

A hemp wick is made by providing a wound ball hemp rope. The wound ball is steeped and decanted, repeatedly, in a water solvent at a temperature sufficient to reach the boiling point the water solvent so that a clear and colorless decantate of the water solution is released. The ball of rope is then dried, and the dried ball is saturated with a liquid beeswax solution which is substantially free of impurities. After saturation the beeswax saturated ball of rope is frozen. After freezing, the saturated beeswax ball of rope is unwound and cut into stripes of a predetermined length which are desirable for use in packaging of the hemp wick to be produced by the method according to the present invention.

### CROSS REFERENCE TO RELATED APPLICATIONS

None.

### BACKGROUND OF THE INVENTION

1. Field of the Invention

The present invention relates to vegetable fiber wicks. In particular, it relates to an improved method for making a hemp wick and the hemp wick made thereby.

2. Description of the Related Art

Organic hemp wicks are used as a healthier alternative to the use of butane fuel for lighting cigars, pipes, hand rolled tobacco or medicinal herbs without contaminating the true flavor of the material to be lit. Hemp wicks are also waterproof and do not degrade over time properties which make hemp wicks ideal for use in winter sports, boating, camping and anywhere in which the air is not dry. Truly organic hemp wicks, are the most desirable, and typically consist of a length of hemp rope saturated with beeswax. Hemp wicks are also desirable in that, when lit, they produce very little ash with no noticeable odor. Thus, hemp wicks have become ever increasingly popular in use as a means of lighting organic materials where one desires a clean burning flame without experiencing the noxious organic chemicals which are emitted with the use of a butane flame.

Hemp wicks are initially derived through the retting process, of decorticating hemp bast fibers, in order to remove pectin containing materials and coloring gums from the raw bast fibers. In this manner, the decorticated plant bast fiber is then typically washed in a solution containing surface active agents which are necessary in order to for the solution to penetrate the plant bast fibers, and to further remove certain water soluble materials together with other contaminate particles. The washed plant bast fibers are then rinsed and treated with aqueous acidic solutions, often including enzymes such as fungal pectinase, in order to further remove the pectin from the plant fiber. Additional processing steps often include retting in basic hydroxides, such a sodium hydroxide, over an elevated temperature, for a period of time to further enhance the degumming process.

The resultant fibers are then subjected to further processing steps which are predetermined in relation to the certain desired applications for final use of the fiber, including the manufacture of fiber based textiles, yarns, and ropes. When used as a starting material in the manufacture of yarns or ropes, the fibers are tightly twisted into a rope and wound onto an open reel. It is such a wound ball of hemp rope which is the a good starting material for subsequent processing in the manufacture of a hemp wick final product.

It can therefore be appreciated, that even after the retting process, the wound ball of hemp rope still contains various impurities within the fiber which are not desirable in the applications for use as a clean burning hemp wick. Thus, what is need is an improved method for making a clean burning hemp wick which is substantially free of impurities, but which is easily ignited, odor free when burned, and waterproof The present invention satisfies these needs.

### BRIEF SUMMARY OF THE INVENTION

It is therefore an object of the present invention to provide an improved method for making a clean burning hemp wick which is substantially free of impurities, but which is easily ignited, odor free when burned, and waterproof.

It is another object of the present invention to provide a hemp wick made by a process which enables the hemp wick to be substantially free of impurities, but which is easily ignited, odor free when burned, and waterproof.

To overcome the problems associated with the prior art, and in accordance with the intent and purpose of the present invention, as embodied and broadly described herein, briefly a hemp wick is provided from a wound ball hemp rope saturated with beeswax. The wound ball is steeped and decanted, repeatedly, in a water solvent at a temperature which is sufficient to reach the boiling point the water solvent, so that a clear and colorless decantate of the water solution is released. The ball of rope is then dried, and the dried ball is saturated with a liquid beeswax solution which is substantially free of impurities. After saturation, the beeswax saturated ball of rope is frozen solid. After freezing, the saturated beeswax ball of hemp rope is unwound, and cut into strips, of a predetermined length, which are desirably sized for use in packaging the final product as a hemp wick.

Additional advantages of the present invention will be set forth in part in the description that follows, and in part will be obvious from that description or can be learned from practice of the invention. The advantages of the invention can be realized and obtained by the invention particularly pointed out in the appended claims.

### BRIEF DESCRIPTION OF THE SEVERAL VIEWS OF THE DRAWINGS

The accompanying drawing, which is incorporated in and which constitute a part of the specification illustrates at least one embodiment of the present invention and, together with the description, explains the principles of the invention.

FIG. 1 is a flow diagram illustrating the method of making the hemp wick in accordance with the present invention.

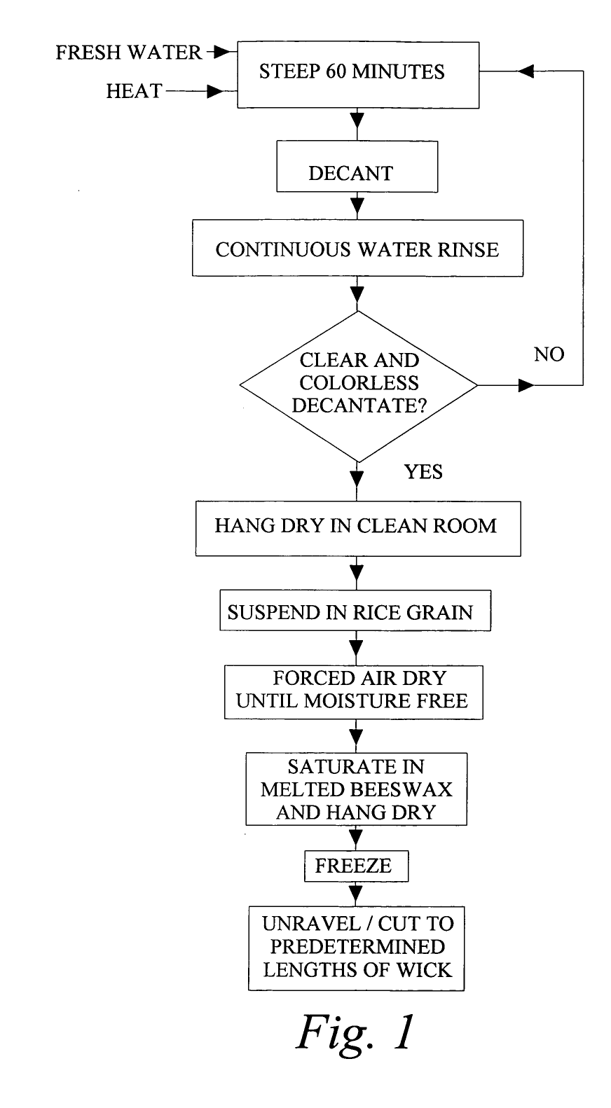

### DETAILED DESCRIPTION OF THE INVENTION

Unless specifically defined otherwise, all technical or scientific terms used herein have the same meaning as commonly understood by one of ordinary skill in the art to which this invention belongs.

Although any of the methods and materials similar or equivalent to those described herein can be used in the practice or testing of the present invention, the preferred methods and materials are now described. Reference will now be made in detail to the presently preferred embodiments of the invention, an example of which is illustrated in the accompanying drawing.

Referring now to the drawing figure, a hemp wick is made by providing a wound ball hemp rope. The wound ball is steeped and decanted, repeatedly, in a water solvent at a temperature which is sufficient to reach the boiling point the water solvent so that a clear and colorless decantate of the water solution is released. The ball of rope is then dried, and the dried ball is saturated with a liquid beeswax solution which is substantially free of impurities. After saturation, the beeswax saturated ball of rope is frozen solid and allowed to dry. After freezing the saturated beeswax ball of rope is unwound, and cut into strips in predetermined lengths which are suitable for packaging in either wholesale or retail quantities.

### EXAMPLE

By way of example, without limitation, the starting material for the hemp wick in accordance with the present invention is desirably a one-hundred-percent natural hemp fiber rope which is has been previously wound on a reel and into a ball. Thus, the ball includes a clear hole which axially extends through the center of the ball for use in securing the ball for processing as a hemp wick. Such balls of hemp rope are typically made and sold in countries such as the United States, Canada, or China. In this example, one ball of hemp rope is unraveled to a length of approximately 18.3 meters. The unraveled length is cut into 7.6 cm lengths, and the lengths are further separated into individual strands for use as ties. One end of a single strand is then moistened and threaded through the clear hole in another wound ball of hemp rope. The two ends of the strand are then tied together, by grasping both ends of the single strand and making a square knot, to thereby secure the ball of rope for use in handling the balls of hemp rope throughout the remaining steps of the process. These steps are repeated for each ball of rope to be used in the production of the hemp wick, in accordance with the present invention.

The wound balls are steeped and decanted, repeatedly, in a water solvent at an elevated temperature which is sufficient to reach the boiling point the water solvent so that a clear and colorless decantate of the water solution is released. In this example, fifteen of the tied balls of hemp rope are then placed in a large stainless steel vessel, and the vessel is filed with clean water to a level where all of the balls are completely submerged. The vessel is then placed on a burner, or hot plate, and the water is heated to its boiling point, such as 100° C., at standard temperature and pressure. The water is allowed to boil for approximately thirty minutes with circulation, such as stirring, and repositioning the balls in the vessel. The balls are then allowed to further steep in the boiling water for another thirty minutes at which time the water typically becomes cloudy with suspended water soluble impurities and debris. The water is then decanted into a container and the balls are repositioned in the vessel, from top to bottom, in relation to one another. If the decantate water is not observed to have been clear and colorless, the vessel is refilled with hot water, and then again brought to boil. The above steps of stirring for thirty minutes and decanting every sixty minutes are repeated twelve times per day, for seven days. After one week, the balls of hemp rope are positioned in a strainer, and rinsed in a continuous flood of cold water with a single rotation of their respective positions, as they relate to one another, every thirty minutes. The rinsing and thirty minute rotation steps are repeated continuously for a period of five days. After the five day period, the balls are then placed back into the vessel and the above steeping, rotating, and decanting steps are carried out for another seven days or until the water solvent decantate is observed to be substantially clear and colorless.

Once all of the debris, and water soluble chemicals are finally washed from the hemp rope balls, and the rinse water is running clear and colorless, the balls are then allowed to dry in the vessel over-night. The hemp balls of rope are then removed from the vessel and hung, by the ties of hemp rope, for one week in a clean room in order to start the drying process. Thereafter, the balls of hemp are then evenly positioned in large bags of rice grain, and allowed to desiccate while submerged in the rice grain for a period of one-week. After that one-week period, the balls of hemp rope are once again hung by their ties in the clean room and air dried with forced air, using fans positioned in order to force air in all directions. Throughout this air drying procedure, the balls are repeatedly spun, or rotated, on the ties once for every twenty minutes of elapsed time. The steps of forced air drying and spinning are desirably repeated for a least one week, or until all of the balls are substantially free of any moisture.

Solid 2.3 Kg bricks of 100% organic beeswax are then heated, on low heat, in a non-stick pan for approximately two hours, or until all of the beeswax is melted into a liquid state, and eight balls of hemp, or less, are then completely submerged into the melted beeswax. The melted wax is then allowed to settle, for approximately fifteen minutes, or until the balls of hemp are completely saturated, in wax, which is evident by observation that all of the air bubbles have been emitted from the balls when submerged. Each of the balls are then removed from the liquid wax, one-at-a-time, and allowed to drip dry for a period of five minutes while being positioned over the pan of melted wax. The balls of beeswax saturated wax are then allowed to hang on drying hooks, where they are spun continuously for approximately ten minutes, until all of the excess was is removed for the balls of hemp rope, by dripping.

The saturated beeswax hemp wick balls are then placed in a freezer and frozen at 0° C. for a period of twenty-four hours, or until they are assuredly transformed into a solid state of hemp rope and beeswax. The single tie strands of hemp rope are then cut, and the entire ball of hemp rope is unwound around two posts. Finally, the unwound hemp wick is cut into predetermined lengths, or sections, in a range of forty-five centimeters to thirty meters, dependant on the intended packaging for use and sale as a retail or wholesale product.

While the present invention has been described in connection with the embodiments as broadly described and illustrated above, it will be appreciated and understood by one of ordinary skill in the art that certain modifications may be made without departing from the true spirit and scope of the invention, as described and claimed herein.

I claim:

1. A hemp wick made by a process, comprising the steps of:
(a) providing a wound ball of a hemp rope;
(b) steeping and decanting the ball of rope in a water solvent at a temperature sufficient to reach the boiling point the water solvent so that a substantially clear and colorless decantate of the water solution is released;
(c) drying the ball of rope;
(d) saturating the ball of rope with a liquid beeswax solution which is substantially free of impurities;
(e) drying the ball of beeswax saturated rope;
(f) freezing the dried beeswax saturated ball of rope;
(g) unwinding the beeswax saturated ball of rope; and
(h) cutting the beeswax saturated ball of rope into a strip having a predetermined length.

2. The hemp wick made according to the method of claim 1, wherein the step of drying is an air dry step carried out in a clean room.

3. The hemp wick made according to the method of claim 1, wherein the step of drying the ball of rope further includes desiccating the ball of rope in contact with a rice grain.

4. The hemp wick made according to the method of claim 1, wherein after the step of steeping the method further comprising the step of rinsing with an aqueous solution and then drying the ball of rope.

5. A method for making a hemp wick, comprising the steps of:
(a) providing a wound ball hemp rope;
(b) steeping and decanting the ball of rope in a water solvent at a temperature sufficient to reach the boiling point the water solvent so that a substantially clear and colorless decantate of the water solution is released;
(c) drying the ball of rope;
(d) saturating the ball of rope with a liquid beeswax solution which is substantially free of impurities;
(e) drying the ball of beeswax saturated rope;
(f) freezing the dried beeswax saturated ball of rope;
(g) unwinding the beeswax saturated ball of rope; and
(h) cutting the beeswax saturated ball of rope to a strip having a predetermined length.

6. The method according to claim 5, wherein the step of drying is an air dry step carried out in a clean room.

7. The method according to claim 5, wherein the step of drying the ball of rope further includes desiccating the ball of rope in contact with a rice grain.

8. The method according to claim 5, wherein after the step of steeping the method further comprising the step of rinsing with an aqueous solution and then drying the ball of rope.
